(19) United States
(12) Patent Application Publication
(10) Pub. No.: US 2024/0094109 A1
(43) Pub. Date: Mar. 21, 2024

(54) COUNTING CHAMBERS AND APPLICATIONS THEREOF, METHODS AND SYSTEMS FOR ANALYZING PARTICLES IN TEST SAMPLES

(71) Applicant: SHANGHAI RUIYU BIOTECH CO., LTD., Shanghai (CN)

(72) Inventors: Puwen LUO, Shanghai (CN); Kai CHEN, Shanghai (CN); Weiya FAN, Shanghai (CN)

(73) Assignee: SHANGHAI RUIYU BIOTECH CO., LTD., Shanghai (CN)

(21) Appl. No.: 18/520,607

(22) Filed: Nov. 28, 2023

Related U.S. Application Data
(63) Continuation of application No. PCT/CN2022/095776, filed on May 27, 2022.

(30) Foreign Application Priority Data
May 28, 2021 (CN) 202110595140.8
May 28, 2021 (CN) 202121186137.2

(51) Int. Cl. G01N 15/14; G06V 10/10; G06V 10/774; G06V 20/69

(52) U.S. Cl. CPC G01N 15/1434; G06V 10/16; G06V 10/774; G06V 20/693; G06V 20/695; G06V 20/698; G01N 2015/1006; G01N 2015/1486

(57) ABSTRACT

The present disclosure provides a counting chamber and an application thereof, and a method and a system for analyzing particles in a test sample. The method includes obtaining a full volume image of the test sample using an image acquisition device, wherein an imaging field of the full volume image is capable of reflecting an entire volume of the test sample in a sample container. The method further includes determining an analysis parameter of the particles in the test sample based on the full volume image, wherein the analysis parameter of the particles includes at least a count of the particles.

### CROSS-REFERENCE TO RELATED APPLICATIONS

This application is a Continuation of International Application No. PCT/CN2022/095776, filed on May 27, 2022, which claims priority to Chinese Patent Application No. 202121186137.2, filed on May 28, 2021, and Chinese Patent Application No. 202110595140.8, filed on May 28, 2021, the entire contents of each of which are hereby incorporated by reference.

### TECHNICAL FIELD

The present disclosure relates to the field of biomedicine, specifically relating to counting chambers and applications thereof, and methods and systems for analyzing particles in test samples.

### BACKGROUND

In the fields of biomedicine, inspection, testing, etc., it is necessary to detect particles in a liquid sample or a semi-solid sample (e.g., a transparent gel, etc.) to determine a count or a concentration of the particles in the sample. Traditional methods for detecting particles in the liquid sample may involve sampling detection, such as using a particle counter, to determine the count of the particles. However, this sampling detection may not accurately reflect the true value of the particles in the sample and has an error.

Therefore, there is an urgent need for a method to detect particles in test samples to improve the accuracy of detection.

### SUMMARY

One embodiment of the present disclosure provides a method for analyzing particles in a test sample. The method may include obtaining a full volume image of the test sample using an image acquisition device. An imaging field of the full volume image may be capable of reflecting an entire volume of the test sample in a sample container. The method may further include determining an analysis parameter of the particles in the test sample based on the full volume image. The analysis parameter of the particles may include at least a count of the particles.

One embodiment of the present disclosure provides a system for analyzing the particles in the test sample. The system may include a full volume image acquisition module and an analysis parameter acquisition module. The full volume image acquisition module may be configured to obtain a full volume image of a test sample based on an image acquisition device. An imaging field of the full volume image may reflect an entire volume of the test sample within a sample container. The analysis parameter acquisition module may be configured to determine an analysis parameter of particles in the test sample based on the full volume image. The analysis parameter of the particles may include at least a count of the particles. In some embodiments, the method for analyzing particles in the test sample may be implemented by a system for analyzing the particles in the test sample.

One embodiment of the present disclosure provides a counting chamber. The counting chamber may include a carrier. The carrier may be provided with a concave sample sink, and at least one marker for image stitching may be provided in the sample sink.

One embodiment of the present disclosure provides a counting method. The counting method may be implemented by the counting chamber for counting. The counting method may include adding the test sample to the sample sink.

One embodiment of the present disclosure provides an application of the above counting chamber as the sample container in a system for analyzing particles in a test sample. The system for analyzing the particles in the test sample may be the above mentioned system for analyzing the particles in the test sample.

### BRIEF DESCRIPTION OF THE DRAWINGS

The present disclosure will be further illustrated by way of exemplary embodiments, which will be described in detail through the accompanying drawings. These embodiments are not limiting, and in these embodiments the same numbering indicates the same structure, wherein:

FIG. 1 is a illustrating a method for particle counting using a hemocytometer according to some embodiments of the present disclosure;

FIG. 2 is a flowchart illustrating an exemplary process for analyzing particles in a test sample according to some embodiments of the present disclosure;

FIG. 3 is a flowchart illustrating an exemplary process of obtaining a full volume image of a test sample through image stitching according to some embodiments of the present disclosure;

FIG. 4 is a schematic diagram illustrating determining a plurality of imaging fields on an imaging surface of a sample container according to some embodiments of the present disclosure;

FIG. 5 is a schematic diagram illustrating stitching of adjacent detection images according to some embodiments of the present disclosure (with an overlapping region);

FIGS. 6A-6B are schematic diagrams illustrating a system for analyzing particles in a test sample according to some embodiments described in the present disclosure;

FIG. 7 is a schematic diagram illustrating an exemplary counting chamber according to some embodiments of the present disclosure;

FIG. 8 is a schematic diagram illustrating another exemplary counting chamber according to some embodiments of the present disclosure;

FIG. 9 is a top view of a counting chamber according to some embodiments of the present disclosure;

FIG. 10 is a front view of the counting chamber according to some embodiments of the present disclosure;

FIG. 11 is a front view of a counting chamber according to some other embodiments of the present disclosure;

FIG. 12 is a side view of the counting chamber according to some other embodiments of the present disclosure;

FIG. 13 is a schematic diagram of dimensions of a counting chamber according to some embodiments of the present disclosure; and

FIG. 14 is a schematic diagram illustrating an exemplary stitching adjacent detection images according to some embodiments of the present disclosure (without overlapping regions).

Explanation of reference numerals in the drawings: 3—sample container, 11, 12, 13, 21, 22, 23, 31, 32, 33—imaging fields, 400—system, 410—full volume image acquisition module, 420—analysis parameter acquisition module, 412—imaging field determination unit, 415—detection image acquisition unit, 417—image stitching unit, 500 counting chamber, 510—carrier, 511—sample sink, 6, 7, 8, 9—markers, 520—imaging target surface, 530—cover, 531—sample loading hole, 532—exhaust hole, 540—slop.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor, unless otherwise indicated or stated in the context, the same reference numerals in the drawings represent the same structures or operations.

It should be understood that the terms “system,” “device,” “unit,” and/or “module” used in the present disclosure are used to distinguish different components, elements, parts, or assemblies at different levels. However, if other words may achieve the same purpose, they may be replaced by other expressions.

As shown in the present disclosure and the claims, unless explicitly indicated otherwise in the context, words such as “one”, “a”, “a kind of”, and/or “the” do not specifically denote the singular form and may also include the plural form. In general, the terms “comprising” and “including” only suggest the inclusion of steps and elements that have been explicitly identified, and these steps and elements do not constitute an exclusive listing; methods or devices may also include other steps or elements.

Flowcharts are used in the present disclosure to illustrate the steps performed by the system according to the embodiments of the present disclosure. It should be understood that the operations mentioned earlier or later are not necessarily executed in a precise sequence. Instead, they may be processed in reverse order or simultaneously. Other operations may also be added to these processes or certain steps may be removed from these processes.

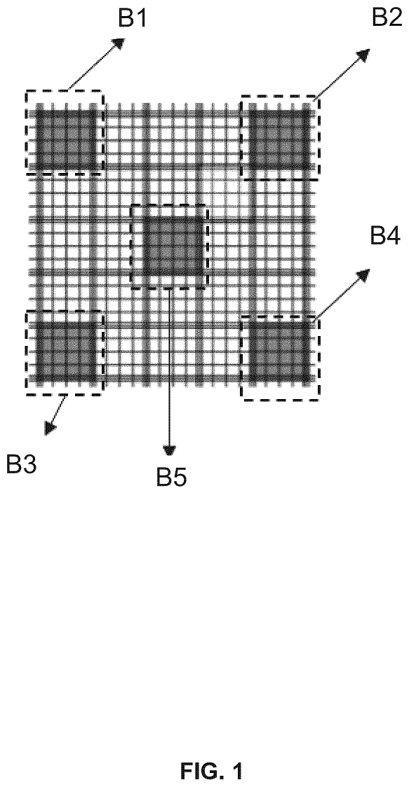

Image-based particle counting techniques are widely used in the field of biomedicine and testing. Traditional counting techniques involve a sampling-statistical approach in conjunction with a hemocytometer. FIG. 1 is a schematic diagram of a grid layout of a hemocytometer. The hemocytometer is provided with 25 large grids arranged in a 5×5, and each large square includes 16 small grids as shown in the diagram. During counting, a sample is taken by manually counting or using a counter, and a statistical technique is employed to determine a total count of particles on the entire hemocytometer. Specifically, a certain count of large grids (exemplarily, the five shaded regions B1, B2, B3, B4, and B5 as shown in FIG. 1) are selected, and an average count of particles for each of the selected large grids is obtained. The average count of particles for each of the selected large grids is then used to determine the total count of particles on the entire hemocytometer. In some embodiments, a count of particles per unit volume, i.e., a particle concentration, may be determined given a known volume of the hemocytometer. Assuming a total count of particles in the five large grids B1, B2, B3, B4, and B5 in FIG. 1 is 1000, the total count of particles (i.e., a total count of particles obtained through imaging detection, denoted as N) on the hemocytometer may be determined as 1000/(5*25)=5000. If the volume of the hemocytometer is 1 ml (in practical applications, the volume/(SD) is determined typically based on an imaging detection area S (mm²) and a depth D (mm)), then the final particle concentration is 5000 particles per milliliter (c=N/(S*D)*1000 (unit: particles/ml)).

However, when using the above method for particle counting and statistics, two types of errors may occur. One is a distribution error of particles within the hemocytometer (the imaging detection area S may have a distribution error). The distribution error may be related to a distribution of particles within the hemocytometer. Since the distribution of particles within the hemocytometer is uneven, counts of particles in each grid of the counting chamber varies, and counting particles only in a portion of the volume of the counting chamber may lead to the distribution error. For example, when counting only particles in a volume corresponding to the five large grids B1, B2, B3, B4, and B5 in FIG. 1, due to the uneven distribution of particles, the count of particles in these five large grids does not accurately reflect the actual count of particles within the hemocytometer.

The other type of error is a manufacturing process error arising from a manufacturing process of the hemocytometer (the depth D of the hemocytometer may have an error due to the manufacturing process). The manufacturing process error in the hemocytometer may lead to a difference between a liquid volume in the hemocytometer and a required volume, ultimately affecting an actual counting result. For example, if the hemocytometer with a volume of 1 milliliter is required, and due to the manufacturing process error, the actual volume of the hemocytometer may deviate (exemplarily, it may be 1.1 milliliters). When determining the particle concentration, the concentration obtained by dividing the statistical count of particles by an imprecise volume is evidently inaccurate.

To address the aforementioned errors, one or more embodiments in the present disclosure propose a method for analyzing particles in a test sample. The method may include obtaining an image that reflects an entire volume state of the test sample through an image acquisition device (i.e., obtaining a full volume image that allows the imaging detection of the total count of particles (referred to as N (particles)). Based on the full volume image, an analysis parameter of the particles in the test sample may be determined. Accordingly, sampling when using the hemocytometer for particle counting may be not involved, thereby avoiding the error caused by uneven particle distribution.

Additionally, the method for obtaining the analysis parameter through the full volume image, as described in the present disclosure, may enable a volumetric measurement during a measurement process, thus mitigating the manufacturing process error arising from the manufacturing process of the hemocytometer. Specifically, relevant personnel or equipment may directly place the test sample whose volume (e.g., 1 ml) needs to be measured into a sample container (an imaging detection volume is a sample loading volume V (μl), which is converted to V (ml)). The manufacturing process of the sample container does not affect the concentration determination (i.e., particle concentration is determined as: c=N/V*1000 (unit: particles/ml)). The method for analyzing particles in a test sample as described in the present disclosure eliminates the distribution error and the manufacturing process error mentioned above, significantly extends a lower limit of concentration detection, does not introduce additional errors in the detection process, and ultimately ties the error in particle counting to sampling or the sample volume V. That is, the method for analyzing particles in a test sample as described in the present disclosure helps to avoid the impact of the manufacturing process error on the counting process and enhances counting accuracy.

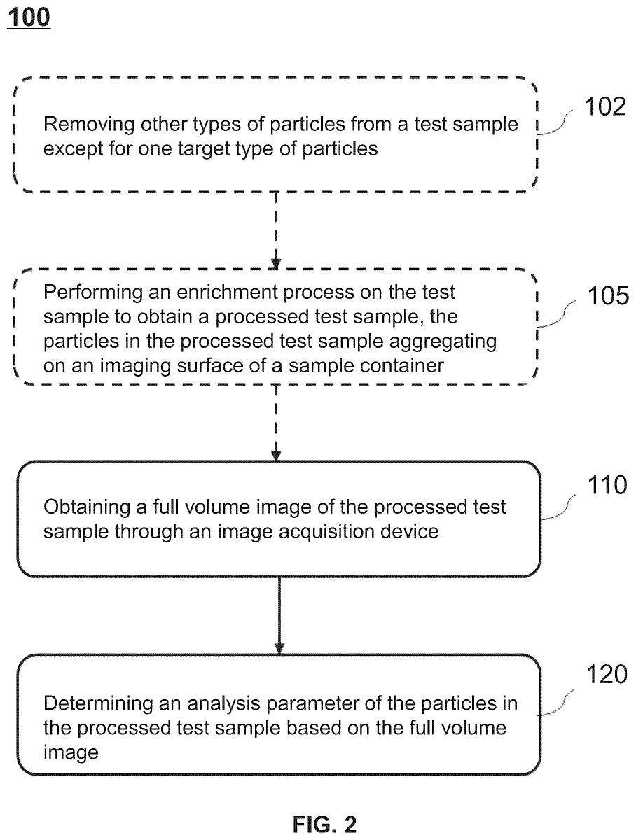

FIG. 2 is a flowchart illustrating an exemplary process for analyzing particles in a test sample according to some embodiments of the present disclosure.

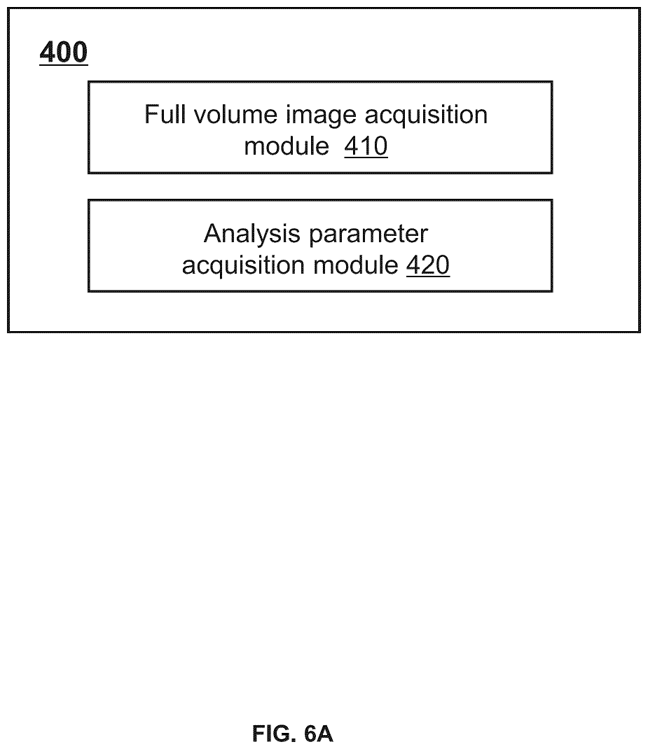

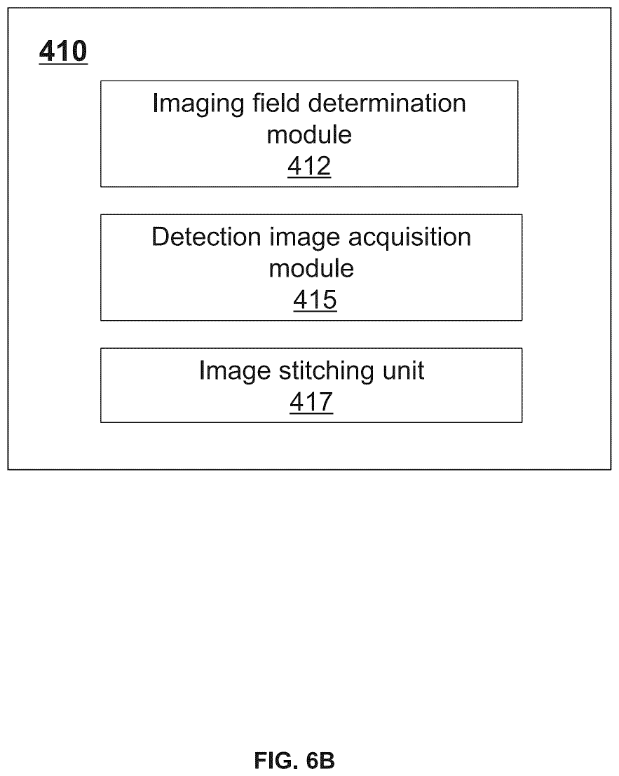

In some embodiments, process 100 as shown in FIG. 2 may be executed by a hardware device under manual control. In some embodiments, process 100 may be executed by any computing device. Specifically, process 100 may be executed by a system 400 for analyzing particles in a test sample as shown in FIG. 6A.

In 110, the system 400 for analyzing the particles in the test sample may obtain a full volume image of the test sample acquired by an image acquisition device.

The image acquisition device may include an image acquisition unit, for example, any type of camera, including a still camera, a video camera, a high-speed camera, a 3D depth camera, an infrared camera, etc. The image acquisition device may include a magnification imaging unit, for example, an optical microscope, a magnifier, an electron microscope, etc., to obtain an image of smaller-sized particles.

In some embodiments, the test sample may include a liquid sample, a semi-solid (e.g., a gel) sample, a solid (e.g., transparent solid) sample. The image of the test sample may be acquired by the image acquisition device. For example, the test sample may include a biological sample, such as milk, urine, cerebrospinal fluid, or other tissues containing cells (e.g., blood).

The test sample may contain particles. In some embodiments, the particles in the test sample may include a cell, for example, a red blood cell, a T cell, a white blood cell, etc. In some embodiments, the particles in the test sample may include other particles, such as a magnetic bead. In some embodiments, a diameter of the particles may depend on a magnification factor of the image acquisition device. Therefore, a small-diameter biological particle such as a bacterium, a virus, and a platelet may be observed using the method described in the present disclosure.

The imaging field of the full volume image may include an entire volume of the test sample in a sample container. For example, if the test sample is 1 milliliter in total, all images of the entire 1 milliliter test sample in the sample container may be directly obtained using the image acquisition device for particle counting.

In some embodiments, operation 110 may be performed by a manual operation, and the full volume image of the test sample may be collected by controlling the image acquisition device manually.

In some embodiments, operation 110 may be performed by an automatic control module. Specifically, operation 110 may be executed by a full volume image acquisition module 410.

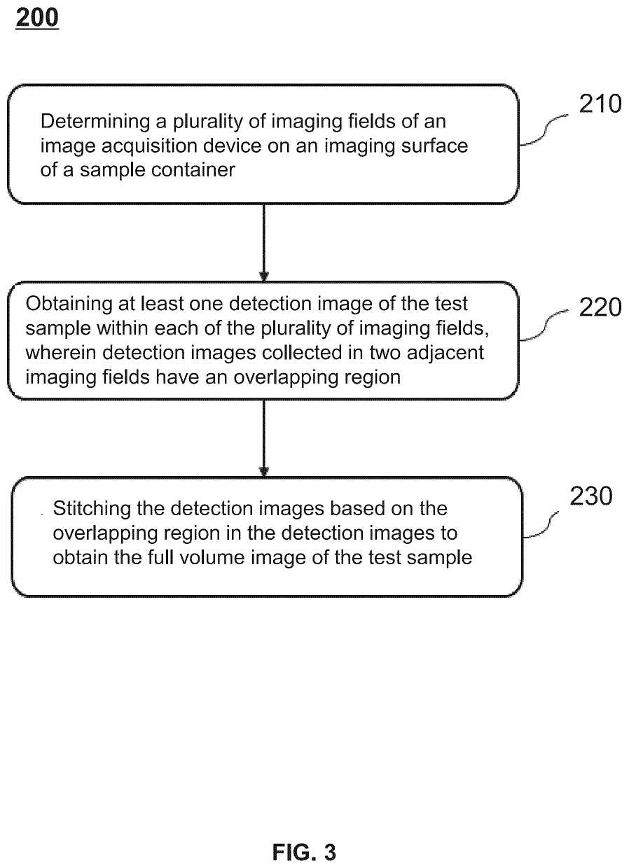

In some embodiments, when the imaging field of the image acquisition device covers the entire volume of the test sample, the full volume image may be obtained. In some embodiments, due to a limitation in the imaging field of the image acquisition device, images corresponding to a plurality of imaging fields may be stitched together to obtain the full volume image representing the entire volume of the sample in the sample container. For example, the full volume image acquisition module 410 may obtain images by continuously imaging the sample container while moving the sample container in a single direction and stitching the images together to obtain the full volume image. More descriptions for obtaining the full volume image through image stitching may be found in FIG. 3 and related descriptions thereof.

In some embodiments, the full volume image may be obtained through bright field imaging. The bright field imaging refers to imaging an object (e.g., the test sample) under a condition of natural light (which is a composite light). In a bright field, specific angles may be formed between a light source and the particles, allowing most of the light to be reflected/transmitted through the particles to the image acquisition device. In the bright field, a background is bright, while edges of the particles are dark. For example, if the particles are cells, the background in the bright field image is bright, and the edges of the cell, cell fragments, and impurities appear dark. Based on a shape of a target object (e.g., cells) in the full volume image, the target object (e.g., cells) may be differentiated, and a count of the target objects (e.g., cells) may be determined.

In some embodiments, the full volume image may be obtained through fluorescent imaging. The fluorescent imaging refers to imaging a particle that is previously stained with a fluorescent dye. The same fluorescent dye may result in varying levels of staining for different particles, causing different particles to emit different wavelengths of fluorescence when excited by a light source. This allows different particles to appear in different colors in an image (e.g., the full volume image) collected by the image acquisition device, enabling counting and analysis. Continuing with the example of the particles as the cells, a fluorescence dye may be acridine orange (AO). AO has membrane permeability and may pass through a cell membrane, causing a live cell to exhibit green or yellow-green fluorescence, which may be used to determine a count of the cells.

In some embodiments, the full volume image may be obtained through scattered light imaging. The scattered light imaging is a technique that utilizes light emitted from a light source to illuminate particles, and generate an image of the particles based on the scattered light produced by the particles, that may be used to determine a count of the particles based on scattered light produced by the particles. When the light emitted by the light source illuminates the particles, a transparent particle (such as a cell) undergoes both transmission and scattering, while a non-transparent particle (such as an immunomagnetic bead, etc.) only undergoes scattering. When the luminous intensity of the light source falls within a certain range, the scattered light from a transparent particle is too weak to be detected by the image acquisition device. As a result, the image acquisition device may only detect the scattered light from the non-transparent particle and capture an image of the non-transparent particle, thus obtaining the full volume image of non-transparent particles. In some embodiments, the light source may include a monochromatic light source or a polychromatic light source. As used d in the present disclosure, the monochromatic light source refers to a light source that emits light not separating light of other colors when refracted by a Mitsubishi mirror. For example, a light source emitting light in the range of 0.77 to 0.622 micrometers may be referred to as a red light source. As another example, a light source emitting light at only 0.66 micrometers may also be referred to as the red light source. The polychromatic light source refers to a light source that emits light consisting of two or more monochromatic lights. An exemplary monochromatic light source may include a red light source, an orange light source, a yellow light source, a green light source, a cyan light source, a blue light source, a purple light source, etc. An exemplary polychromatic light source may include a red-green polychromatic light source, a yellow-purple polychromatic light source, a red-blue polychromatic light source, a blue-purple polychromatic light source, a white light source, etc. The scattered light imaging is typically suitable for a scenario where the transparent and non-transparent particles (such as the immunomagnetic bead) need to be distinguished. In some embodiments, to ensure a significant difference in the intensity of the scattered light between the transparent and the non-transparent particles, so that the image acquisition device may only detect the scattered light from the non-transparent particle and not from the transparent particle, or to ensure that the intensity of the scattered light from the non-transparent particle is greater than the intensity of the scattered light from the transparent particle, an intensity of incident light (or light emitted by the light source) may not be too strong.

In 120, the system 400 for analyzing the particles in the test sample may determine, based on the full volume image, an analysis parameter of particles in the test sample.

In some embodiments, the analysis parameter of the particles may include a count of the particles. In some embodiments, the analysis parameter of the particles may include a parameter characterizing a state of the particles in the test sample. Specifically, the parameter characterizing the state of the particles may include one or more of a particle type, a morphological parameter, a particle concentration, a distribution of the particles in different regions or locations of the test sample, or a combination thereof.

The particle type may include an attribute of the particles. For example, the particle type may include a cell, a microbead, etc. In some embodiments, the cell and the microbead may be distinguished through fluorescent imaging by using different fluorescent dyes. In some embodiments, different particle types may be differentiated based on a size of the particles. In some embodiments, the particle type may be a further categorized attribute. For example, the particle type may include a specific cell type such as a red blood cell, a white blood cell, a platelet, etc. As another example, the particle type may include a live cell, an apoptotic cell, a necrotic cell, a vacuolated cell, a cell fragment, an impurity, etc. In some embodiments, the live cell, the apoptotic cell, the necrotic cell, the vacuolated cell, the cell fragment, and the impurity, etc., may be distinguished using a fluorescent staining technique. For example, processing the liquid sample containing cells with acridine orange (AO) and propidium iodide (PI) may help differentiate between a live cell and a dead cell. AO may penetrate both the live and dead cells, staining the cell nucleus and emitting green fluorescence, while PI, lacking membrane permeability, may only enter a damaged cell membrane of the dead cell and emit red fluorescence. When both dyes are present in the cell nucleus, PI may cause a reduction in AO fluorescence through fluorescence resonance energy transfer (FRET), resulting in a red appearance. Therefore, the live cell may accurately differentiate from the dead cell based on AO/PI, excluding impurities or non-specific cell interference, thereby achieving precise concentration and viability testing. The differentiation may be achieved through a color variation in some alternative embodiments, or based on a difference in particle size.

The count of the particles may include at least one of a total count of the particles or a count of particles corresponding to each particle type. For example, the count of particles corresponding to each particle type may include a count of cells or a count of microbeads. As another example, the count of particles corresponding to each particle type may include a count of live cells, a count of apoptotic cells, a count of necrotic cells, a count of vacuolated cells, a count of cell fragments, a count of impurities, etc. In some embodiments, the concentration of particles may be determined based on the count of particles corresponding to a particle type.

The morphological parameter of a particle refers to a parameter that characterize the morphology of the particle. The morphological parameter of a particle may include a diameter, a surface area, a roundness, a contour, agglomeration, a refractive index, a synaptic length, etc., of the particle. The roundness of a particle refers to a similarity degree between the shape of the particle and a theoretical spherical shape. For example, an actual size of a particle (such as a diameter, an outer contour perimeter) may be obtained from a size of the particle in the full volume image, thereby determining the surface area of the particles. Alternatively, the roundness of the particles may be determined based on a difference in diameter in various directions. The agglomeration refers to a characteristic of two or more particles coming together. The synaptic length refers to the length of a synapsis extending outward from a cell body of a nerve cell.

In some embodiments, the analysis parameter of the particles may include at least one of a percentage or a concentration of particles of each particle type. For example, a viability may be used to represent the percentage of live cells to the total count of cells. As another example, the ratio of the count of the particles in the test sample to a volume of the test sample may be determined as the concentration of the particles in the test sample.

In some embodiments, the analysis parameter of the particles may be obtained manually. For example, a count of magnetic beads (e.g., immunomagnetic beads) in the test sample may be determined through manual counting by observing the full volume image.

In some embodiments, the system 400 for analyzing the particles in the test sample may use an algorithm to process the full volume image to obtain the analysis parameter of the particles. In some embodiments, operation 120 may be carried out by an analysis parameter acquisition module 420. In some embodiments, the analysis parameter acquisition module 420 may use an algorithm (e.g., a feature extraction analysis technique) to count the particles. In some embodiments, the analysis parameter acquisition module 420 may using an algorithmic model to identify and segment particles from the full volume image based on a feature parameter within the algorithmic model. For example, the analysis parameter acquisition module 420 may employ an image recognition model to determine the analysis parameter of the particles. As a further example, a target image (e.g., the full volume image) may be input into a processing device, and the processing device may use the image recognition model to determine a count of non-transparent particles. Exemplary image recognition models may include a machine learning model such as a convolutional neural network (CNN) model, a fully convolutional network (FCN) model, or the like, or any combination thereof. It should be noted that the processing device in the present disclosure may process at least one of information or data related to one or more functions described in the present disclosure. In some embodiments, the processing device may include one or more processing units (e.g., a single-core processing engine or a multi-core processing engine). For example, the processing device may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), controllers, microcontroller units, reduced instruction set computers (RISC), microprocessors, or any combination thereof.

In some embodiments, the image recognition model may include an image input layer, a feature extraction layer, and an analysis layer. In the embodiments of the present disclosure, an input of the image recognition model may be the full volume image, and an output may be the analysis parameter of the particles. The image input layer may be understood as a model input for the entire model, used to input the full volume image into the image recognition model.

An input of the feature extraction layer may be the full volume image, and an output of the feature extraction layer may be a shape feature of the particles in the full volume image. In some embodiments, a type of the feature extraction layer may include a Convolutional Neural Network (CNN) model, such as ResNet, ResNeXt, SE-Net, DenseNet, MobileNet, ShuffleNet, RegNet, EfficientNet, Inception, etc., a recurrent neural network (RNN) model, or the like, or a combination thereof. The shape feature represents relevant information about a contour of the particles and indirectly reflect the contour of the particles. Exemplarily, the shape feature may be obtained through a technique such as edge feature extraction, Hough transform for detecting parallel lines, edge direction histograms, Fourier shape descriptor, shape factor calculation, Finite Element Method (FEM), turning function, wavelet descriptor, etc.

The analysis layer in the image recognition model may use the shape feature obtained to determine the analysis parameter of the particles. Taking the analysis parameter as the count of the particles for illustration, the analysis layer may use the shape feature to obtain the count of the particles. For example, the analysis layer may obtain the count of the particles by counting all particles with a circular-like contour.

In some scenarios, the analysis layer may be configured as a classifier model. In this case, the analysis layer may classify the particles based on factors such as the diameter, the shape, etc., of the particles, thereby determining the count of particles in different types. Taking an example of the test liquid being human blood, a platelet diameter ranges from 1 to 4 micrometers and the shape of the platelet is discoidal, all particles with diameter in the range from 1 to 4 micrometers and the shape of discoidal may be counted to determine a count of platelets in the sample. As another example, white blood cells in the human body have diameters ranging from 7 microns to 20 microns and have a spherical shape, all particles with diameters ranging from 7 microns to 20 microns and a spherical shape may be counted to determine a count of white blood cells in the sample.

In some embodiments, the full volume image may be obtained through fluorescence imaging, etc. In this scenario, different particles may have different fluorescence colors. In other words, the full volume image may not only contain shape information of the particles but also color information of the particles. In this case, the output of the feature extraction layer may include a color feature of the particles. Exemplarily, the color feature may be represented using a chromaticity component of a corresponding pixel in the full volume image, such as a red component (R), a green component (G), and a blue component (B).

The color information may reflect the particle type more intuitively. For example, when acridine orange (AO) is used to treat a test liquid containing a cell, AO is membrane-permeable and may penetrate the cell membrane, causing a live cell to emit yellow-green fluorescence. In this scenario, all particles emitting yellow-green fluorescence may be determined form the full volume image based on the color feature of pixels in the full volume image, thereby determining a count of the live cells.

Furthermore, the analysis layer may combine the obtained shape feature and the color feature to determine the count of the particles. For example, in the case of the full volume image obtained using the fluorescent dye acridine orange (AO), the analysis layer may use the color feature (uniform yellow-green fluorescence) to determine an approximate range of the live cells, and then matches the shape feature of particles within that range to finally determine the count of the live cells. It may be understood that solely using the shape feature to determine the count of the particles may lead to inaccuracies in particle counting due to factors like an unclear particle contour, etc., and may introduce an infection of another particle such as a dead cell or a ruptured cell. Combining the shape feature with the color feature allows for a more accurate determination of the count of the particles.

It should be noted that those skilled in the art may make various modifications to the embodiments described in the present disclosure while being aware of these embodiments. For example, the fluorescent dye may include acridine orange (AO), propidium iodide (PI), ethidium bromide (EB), fluorescein isothiocyanate (FITC), or combinations thereof. Such variations still fall within the scope of the present disclosure.

In some embodiments, one or more parameters of the image recognition model may be generated through a training process. For example, a model acquisition module may train an initial image recognition model through iterations using a plurality of labeled training samples, using a model training technique such as a gradient descent algorithm. The plurality of training samples may include labeled sample images, where the labels for the training samples represent reference values of the analysis parameter of the particles in the sample images. In some embodiments, the labels for the training samples may be obtained through manual annotation. In some embodiments, the image recognition model may be pre-trained by a processing device and stored in a storage device, and the processing device may directly call the image recognition model from the storage device.

In some embodiments of the present disclosure, the image recognition model is used to analyze the full volume image, thus obtaining the analysis parameter of the particles, which can improve the efficiency of analysis. Moreover, with different labels for the training samples, image recognition models corresponding to different analysis parameters may be obtained, thereby enhancing the applicability and specificity of particle analysis.

In some practical application scenarios, process 100 may be used to detect a count of CD3/CD28 immunomagnetic beads (hereafter referred to as magnetic beads) in a test sample. The magnetic bead may include a superparamagnetic material enclosed by a polymer material, and is functionalized with a group such as an amino group, a carboxyl group, a hydroxyl group, etc., for covalent or non-covalent coupling with an antibody, which may enable the magnetic bead to bind to a corresponding antigen or antibody for biologic therapy. Specifically, in a production process of a CAR-T cell preparation using the magnetic bead, it is necessary to detect a concentration of the magnetic bead in a solution to meet a quality control requirement of the CAR-T cell preparation. The ratio of the count of the magnetic beads in a test sample to the volume of the test sample may be determined as the concentration of the magnetic bead in the test sample. Furthermore, the concentration of the magnetic bead in the test sample may be compared to a standard content to determine if the test sample is qualified. For example, when the concentration of the magnetic bead is less than a standard concentration (e.g., 500 beads/mL), it indicates that the CAR-T cell preparation is qualified.

In some practical scenarios where a plurality of types of particles are present in the test sample, process 100 may also include in 102, removing other types of particles from the test sample except for one target type of particles.

In some embodiments, when there are two or more types of particles distributed in the test sample, other types of particles from the test sample except for the target type of particles may be removed. In some embodiments, operation 102 may be performed manually. In some embodiments, operation 102 may be performed by a computer processing device, such as a particle removal module (not shown in the figure). In some embodiments, the types of particles in the test sample may include a transparent particle and a non-transparent particle, and if the non-transparent particle is the target type of particles, the transparent particle may be removed from the test sample. For example, the transparent particle may include a cell, and the non-transparent particle may include the magnetic bead. In this scenario's embodiments, full volume imaging of only one type of particles in the test sample may be achieved using fluorescent imaging. For example, when the target type of particles is the cell, staining the cell with a fluorescent dye may eliminate interference from other types of particles in the full volume imaging. In some embodiments, when the target type of particles is the non-transparent particle (e.g., the magnetic bead), imaging of only the non-transparent particle may be achieved using scattered light imaging, thus eliminating interference from the transparent particle (e.g., the cell). More descriptions for the fluorescent imaging and the scattered light imaging, please refer to the corresponding descriptions in 110.

In some embodiments, the test sample may include both the transparent particle and the non-transparent particle, and the non-transparent particle may be the target type of particles. The transparent particle may be lysed by adding a lysis solution to eliminate the interference from the transparent particle in particle detection. For example, the lysis solution may be a 20% sodium dodecyl sulfate (SDS) aqueous solution, which may be used at a final concentration of between 1% and 4% (the final concentration refers to the concentration of SDS in the test sample after adding SDS to the test sample). Exemplarily, the final concentration of the SDS solution may be set at 1%, 1.5%, 2%, or 2.5%. In some embodiments, when lysing the transparent particle using the lysis solution, a lysis reaction may be accelerated by a technique such as heating, stirring, liquid shaking (e.g., using a vortex mixer or an ultrasonic bath) to speed up the reaction of the lysis solution for better and faster lysis of the transparent particle. In some embodiments, the transparent particle may be the cell, and if using an SDS aqueous solution as the lysis solution, the cell may be lysed to avoid the impact of cellular debris on the accuracy of particle detection.

Specifically, f lysing the transparent particle by adding the lysis solution may be used in the detection scenario mentioned above for the CAR-T cell preparation. In the mentioned scenario where the CAR-T cell preparation is used as the test sample, the CAR-T cell preparation contains not only the magnetic bead but also a large count of cells. In this case, the lysis solution mentioned above (such as the SDS aqueous solution) may be used to lyse the cells to obtain a test sample that contains only the magnetic bead, thus removing the interference of cells on the counting of the magnetic bead.

In some embodiments, process 100 may further include operation 105 including performing an enrichment process on the test sample to obtain a processed test sample, and the particles in the processed test sample may aggregate on an imaging surface of a sample container (e.g., a bottom of the sample container). The enrichment process may include centrifugation, settling, magnetic attraction, etc. In some embodiments, the centrifugation may involve placing the sample container with the test sample in a centrifuge for a certain period of time (e.g., 10 seconds, 30 seconds, 1 minute, 1.5 minutes, 2 minutes, etc.). In some embodiments, the settling may involve allowing the sample container with the test sample to be standing a certain period of time (e.g., 30 seconds, 1 minute, 2 minutes, 5 minutes, 10 minutes, 30 minutes, 1 hour, etc.) so that particles settle at the bottom of the sample container. In some embodiments, the magnetic attraction may involve placing the sample container with the test sample on a magnetic plate (e.g., a permanent magnet) for a certain period of time (e.g., 30 seconds, 1 minute, 2 minutes, 5 minutes, 10 minutes, 30 minutes, 1 hour, etc.) if a particle is magnetic (e.g., the magnetic bead), causing the particle (e.g., the bead) to rapidly settle at the bottom of the sample container. In some embodiments, operation 105 may be performed manually. In some embodiments, operation 105 may also be performed by any computer processing device, such as an enrichment processing module (not shown in the figure).

It should be understood that the description of process 100 above is exemplary and not intended to limit the scope of the present disclosure. Those skilled in the art may make various modifications and changes within the scope of the present disclosure. However, these modifications and changes do not depart from the scope of the present disclosure.

FIG. 3 is a flowchart illustrating an exemplary process of obtaining a full volume image of a test sample through image stitching according to some embodiments of the present disclosure.

In some embodiments, process 200 may be performed manually. In some embodiments, process 200 may be performed by any computer processing device. Specifically, process 200 may be performed by the full volume image acquisition module 410 as shown in FIG. 6B.

In 210, a plurality of imaging fields of an image acquisition device on an imaging surface of a sample container may be determined.

In some embodiments, one single imaging field of the image acquisition device may not cover the entire imaging surface of the sample container. In such cases, the plurality of imaging fields may be determined, and image stitching may be performed to obtain the full volume image. The imaging field refers to a region or range the image acquisition device observes and collects an image. It may be understood that in certain scenarios, a size of a particle in the test sample is very small, and for clear observation of the particle, the image acquisition device may use a higher magnification factor for observation. As the magnification factor increases, the image becomes clearer, but the imaging field decreases. When the imaging field decreases to a certain extent, the imaging field may not cover the entire imaging surface of the sample container. Therefore, a plurality of imaging operations may be performed on the imaging surface and images may be obtained from the plurality of imaging operations.

In some embodiments, different imaging magnification factors may be applied to different imaging fields. During the subsequent stitching process, detection images captured from different imaging fields may be adaptively enlarged or reduced for image stitching. Different imaging fields may use different magnification factors to observe a specific region in more detail, obtaining a more accurate measurement result.

In some embodiments, to facilitate stitching, the same magnification may be applied to different imaging fields. Obviously, because the magnification for different imaging fields is the same, sizes of the imaging fields may be the same, and image stitching may be performed directly based on the obtained images.

In some embodiments, determining the plurality of imaging fields and applying different magnifications to different imaging fields may be performed manually, for example, manually determining the magnification factor (e.g., 10×, 20×) and the region covered by the imaging field.

In some embodiments, operation 210 may be executed by an automatically controlled device or software. In some embodiments, operation 210 may be performed by an imaging field determination unit 412.

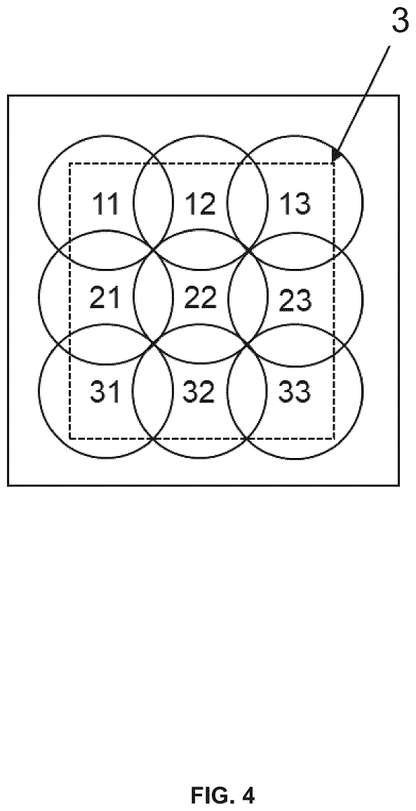

In the following description of the present disclosure, the example of using the same magnification factor for different imaging fields may be used for illustration. FIG. 4 is a schematic diagram illustrating a process for determining a plurality of imaging fields on an imaging surface of a sample container according to some embodiments of the present disclosure. In FIG. 4, “3” represents the sample container, and “11”, “12”, “13”, “21”, “22”, “23”, “31”, “32”, “33” represent the plurality of imaging fields at a same magnification factor (completely identical in size). Clearly, one single imaging field may be used to only obtain an image of a portion of the sample container, and by stitching the plurality of imaging fields, a full volume image covering the entire imaging surface corresponding to the sample container “3” may be obtained.

It should be noted that the configuration of the plurality of imaging fields shown in FIG. 4 is provided for illustrative purposes only and does not limit the scope of the present disclosure in any way. For example, sizes of different imaging fields may be different (e.g., different image magnification factors may result in different sizes of imaging fields). An arrangement of the plurality of imaging fields may be uniformly arranged in any pattern (e.g., circular array, square array, or triangular array), or the arrangement of the plurality of imaging fields may be non-uniform. Such variations are still within the scope of protection of the present disclosure.

In 220, at least one detection image of the test sample within each of the plurality of imaging fields may be obtained, and detection images acquired in two adjacent imaging fields may have an overlapping region.

As shown in FIG. 4, the at least one detection image of the test sample may be obtained in each of the plurality of imaging fields, and in order to perform stitching, detection images acquired in any two adjacent imaging fields have an overlapping region. For example, at imaging field 11, at least one detection image may be obtained, and at imaging field 12, at least one detection image may be obtained, an overlapping region is between the detection images obtained in the imaging fields 11 and 12. The overlapping region may serve as a basis for stitching in subsequent steps. As another example, imaging field 22 is adjacent to the other imaging fields 11, 12, 13, 21, 23, 31, 32, 33, and the detection image obtained in the imaging field 22 has overlapping regions with the detection images corresponding to the aforementioned imaging fields. In some embodiments, the process of obtaining the at least one detection image in 220 may be performed manually, such as adjusting the plurality of imaging fields manually and taking photos with the image acquisition device.

In some embodiments, the obtaining the at least one detection image may be executed by a detection image acquisition unit 415. The detection image acquisition unit 415 may obtain a corresponding detection image acquired by the image acquisition device at a preset position based on a preset program. Furthermore, the detection image acquisition unit 415 may cause the relative movement between the image acquisition device and the sample container to change the imaging field of the image acquisition device to one of the plurality of imaging fields (e.g., from imaging field 11 to imaging field 12). The relative movement between the image acquisition device and the sample container may be achieved in any feasible manner. For example, the image acquisition device may be provided with preset a rail and a motor, and the motor may drive the image acquisition device to move continuously or stepwise in a preset direction along the preset rail. Further, the movement trajectory and a stopping position of the image acquisition device may be preset, allowing for automatic acquisition of detection images for different imaging fields. In some embodiments, the relative movement between the image acquisition device and the sample container may be manually performed. For example, the image acquisition device may not include a motor, and the image acquisition device may be controlled to move manually (e.g., with a nut and a threaded rod provided on the image acquisition device and the sample container respectively, manually rotating the nut to move the image acquisition device).

It should be noted that those skilled in the art may make various reasonable modifications to the technical solutions of the present disclosure based on the present disclosure. For example, the image acquisition device may be immovable, and the sample container may be movable. As another example, a count of the motors, an arrangement of the motors, or a type of the motors may be specifically set based on an actual need. The motor may include a stepper motor, a servo motor, a hydraulic motor, etc. In some embodiments, the movement of the image acquisition device may include belt transmission, chain drive, screw drive, or other transmission manners, allowing the image acquisition device to move under the drive of the motor. Similar variations remain within the scope of protection of the present disclosure.

In 230, the detection images may be stitched based on the overlapping regions in the detection images to obtain the full volume image of the test sample. In some embodiments, operation 230 may be implemented by an image stitching unit 417.

In some embodiments, the image stitching unit 417 may perform stitching based on the overlapping regions in the detection images. In some embodiments, the image stitching unit 417 may perform stitching based on a point feature of the overlapping regions in the detection images. The point feature is a feature of a point in the overlapping region of two adjacent detection images corresponding to two pixels in the two adjacent detection images that represent the same spatial point in the test sample. The point feature may include a color feature, a texture feature, a shape feature, etc., of the two pixels in the two adjacent detection images. The color feature may reflect distribution information of different fluorescence colors of different particles in a region of the full volume image. The texture feature may reflect information on a change in gray scale or color (e.g., gray scale distribution, color sparsity, etc.) in a region of the full volume image. The shape feature refers to a feature of an outline shape (e.g., a particle boundary shape, a shape formed by a plurality of particles combined) of one or more particles. For example, if a particular cell in detection image A has a certain shape feature and the same shape feature of the same cell is determined in detection image B, then the detection images A and B may be stitched together by matching the same shape feature in detection images A and B. As another example, if a certain region in detection image A has a texture feature and the same texture feature is found in detection image B, then the detection images A and B may be stitched together by matching the same texture feature in detection images A and B. Specifically, the image stitching unit 417 may match the same feature points in any two detection images based on techniques such as automatic or semi-automatic feature point search.

In some embodiments, the sample container may be provided with one or more markers, and the overlapping region between the two adjacent detection images may include at least one same marker. As used herein, the overlapping region being between two adjacent detection images refers to that a first region of one of the adjacent detection images and a second region of another one of the adjacent detection images represent the same region of the test sample. The first region and the second region may form the overlapping region. In other words, the overlapping region between the two adjacent detection images including at least one same marker refers to that the at least one marker may be represented in the first region and the second region of the two adjacent detection images. In some embodiments, the at least one marker may be in a same configuration. In some embodiments, the at least one marker may be in different configurations. The configuration of a marker may denote a characteristic of a marker, such as a shape, a size, a material, etc. The same configuration of at least two markers refers to that at least one characteristic of the two markers is the same. In some embodiments, image stitching may be performed sequentially based on the at least one same marker in the two adjacent detection images to obtain the full volume image of the test sample.

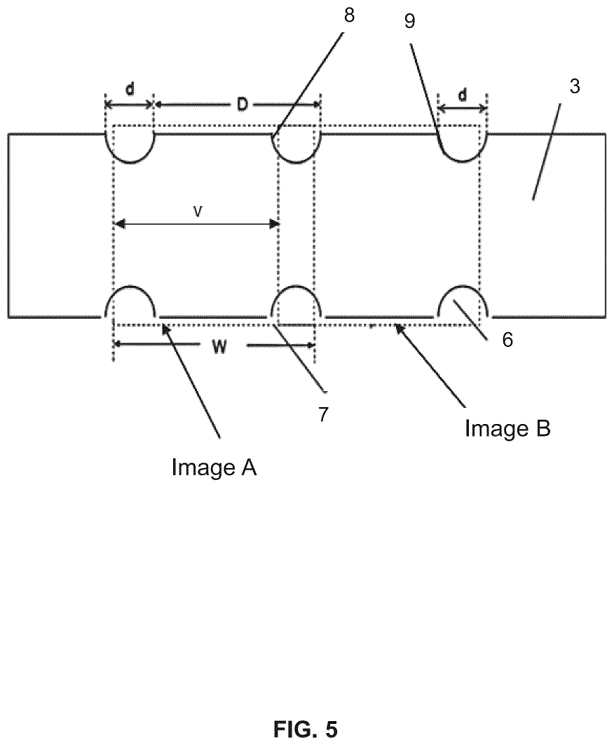

In some embodiments, the one or more markers may be integrally formed with the sample container. In some embodiments, the one or more markers may be added in subsequent operations (e.g., at least one marker may include an identifiable shiny patch that is attached to the sample container). The one or more markers may be located on any observable part of the sample container. For example, the at least one marker may be placed on the bottom of the sample container. Preferably, the at least one marker may be placed on the edge of the sample container (as shown in FIG. 5) for easier production and processing during integral manufacturing.

In some embodiments, at least one of the one or more markers may have any regular shape. The at least one of the one or more markers with a regular shape may be readily distinguished from the particles in the test sample, making the at least one marker easier to identify. For example, the at least one marker may be elliptical, square, polygonal, irregular polygons, or other shapes. As another example, the at least one marker may be in a non-symmetric shape or an irregular shape.

Preferably, the at least one marker may be semi-circular (as shown in FIG. 5). The semi-circular marker may result in a smoother edge during image stitching. If the at least one semi-circular marker is integrally formed with the sample container, the at least one semi-circular marker may have minimal impact on the container's strength, making it easier to manufacture the sample container.

In some embodiments, the sample container may be provided with only one marker. In this case, image alignment may be performed based on an overall (or part) shape of the marker for stitching.

In some embodiments, the sample container may be provided with a plurality of markers. In this scenario, any two adjacent detection images may be stitched based on the at least one same marker, resulting in a well-stitched full volume image.

FIG. 5 is a schematic diagram illustrating stitching of adjacent detection images according to some embodiments of the present disclosure. As shown in FIG. 5, 3 represents a sample container, and 6, 7, 8, and 9 are markers (with 7 and 8 being overlapping markers). Images A and B represent two detection images with adjacent imaging field. The shape of each of the markers in FIG. 5 is exemplarily set as semi-circular. W represents a width of the imaging field corresponding to the detection image, D represents a spacing between the markers, and d represents a width of each of the markers.

As shown in FIG. 5, the maximum width of the sample container 3 may be slightly less than a long side width of the actual e imaging field of an I image acquisition device to ensure that the single imaging field completely covers the width of the sample container 3. The sample container 3 may be exemplarily configured as a rectangular shape (as shown in FIG. 5). As shown in FIG. 5, the markers may be provided on both sides of the detection image to facilitate the stitching of the detection image with adjacent detection images on the both sides of the detection image.

As shown in FIG. 5, images A and B represent the markers 7 and, and the two detection images A and B may be stitched together based on the markers 7 and 8. This process may be performed manually or executed by any computer processing device. In some embodiments, the image stitching unit 417 may include a first alignment module and a second alignment module (not shown in the figure), which are used to perform the following operation 1 and 2. Specifically, the stitching process may include the following operations:

In operation 1, a stitching range for a first alignment operation on the two detection images may be determined and the first alignment operation may be performed on the two detection images based on the stitching range. The first alignment operation may be used to determine a range and a direction for stitching the two detection images. The first alignment operation may also be referred to as a rough alignment operation. The stitching range for the first alignment operation may be used to determine a range of an overlapping region. For example, using FIG. 5 as an example, image A may be divided into a plurality of subparts to match each corresponding-sized subpart in image B one by one to determine the overlapping region. The first alignment operation may be performed based on the overlapping region. In some embodiments, a distance of two imaging fields (also referred to as imaging field distance) corresponding to the two detection images may be determined. In this scenario, the stitching range for the first alignment operation may be related to the imaging field distance. Continuing with the above example, if the imaging field distance between the images A and B is denoted as V a portion of image A acquired by the imaging acquisition device moving a distance V from a location for acquiring image B does not appear in image B. In this case, only the remaining part (i.e., W-V part) of image A may be compared with image B to quickly determine the overlapping region. Preferably, the plurality of markers may be provided at equal intervals on the sample container, and a distance between two adjacent imaging fields is may equal to the spacing D of the plurality of markers. As used herein, a distance between two imaging fields refers to a distance between edges, two center points, etc., of the imaging fields. More preferably, if the width W of the imaging field corresponding to a detection image satisfies the condition D<W<D+d, the overlapping region corresponding to a detection image may be represented in a similar location of a subsequent image (i.e., the adjacent detection image). In this way, the efficiency of determining the overlapping region is further accelerated.

In operation 2, the two detection images may be calibrated based on at least one same marker to obtain a stitched image. Referring to FIG. 5, the rough-aligned detection images A and B (images obtained after the first alignment operation) may be calibrated based on the markers 7 and 8, and the markers 7 and 8 may be both represented in detection images A and B. Furthermore, a smoothing operation may be performed on a stitching edge to obtain the stitched image of the two detection images (e.g., detection images A and B). The smoothing operation refers to adjusting the stitching edge through techniques such as softening, grayscale adjustment, line thickness adjustment, etc., to achieve a smooth transition at the stitching edge.

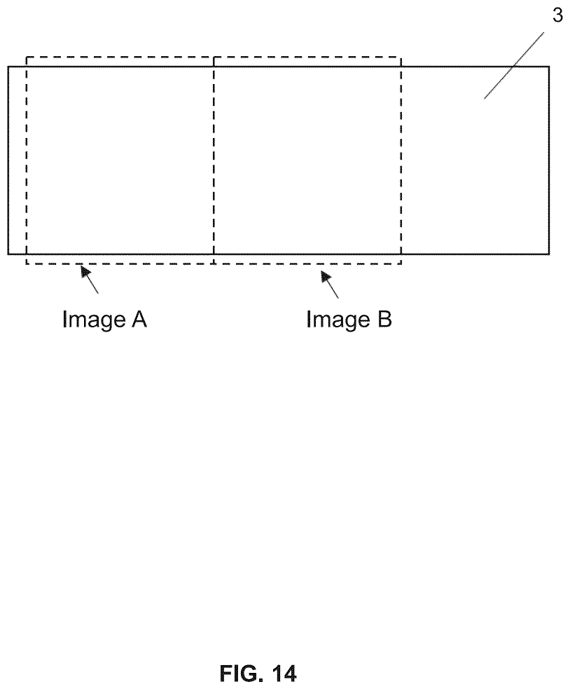

For example, FIG. 14 is a schematic diagram illustrating stitching of adjacent detection images according to some embodiments of the present disclosure (without overlapping regions). The stitching process may be performed manually or executed by any computer processing device. For example, the stitching process may be accomplished directly through the image stitching unit 417, or through absolute precision of detecting image displacement, ensuring successful image stitching.

In some embodiments, the sample container 3 may be a counting chamber 500. The counting chamber may be used for particle and cell recognition and counting, widely applied in the fields of life sciences, biomedicine, and medical testing. Currently, the counting chambers of most cell counters may follow a counting principle of a hemocytometer. For example, a classic hemocytometer counts only a limited volume (random sampling) within a counting chamber and may not achieve full volume imaging counting. Uneven distribution of cells in a counting region results in an inherent distribution error, particularly when a cell concentration is low, significantly increasing this distribution error and greatly reducing counting accuracy. By using a counting chamber that allows full volume imaging of the test sample, the counting accuracy is improved, and a countable range is expanded.

Some embodiments of the present disclosure provide a counting chamber 500. A sample sink 511 of the counting chamber 500 is provided with at least one marker 6 (markers 6, 7, 8, and 9 as shown in FIG. 5 are four markers in a same configuration, with the marker 6 used as an example in the description of the counting chamber) for image stitching and recognition to achieve full volume imaging of a sample inside the sample sink 511. The counting chamber disclosed in the embodiments of the present disclosure has the characteristics of simple structure, easy use, time and labor-saving, and high precision, making the counting chamber particularly suitable for counting measurements of large-volume and low-concentration samples.

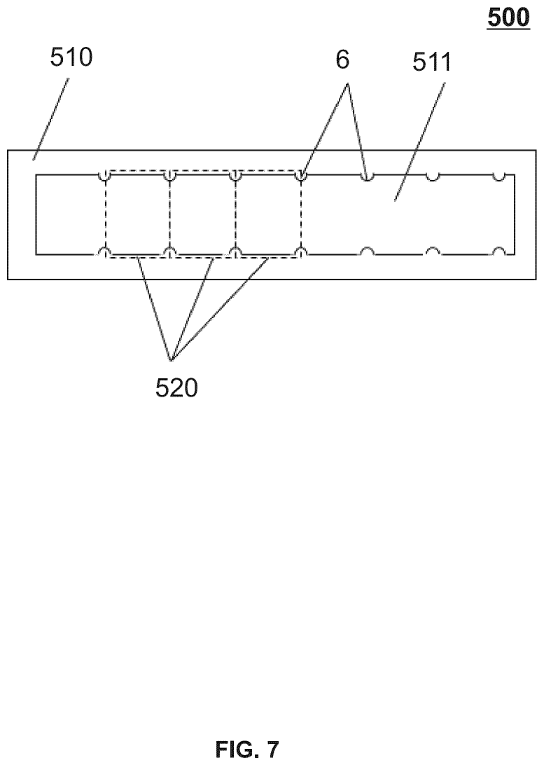

FIG. 7 is a schematic diagram illustrating an exemplary counting chamber 500 according to some embodiments of the present disclosure.

In some embodiments, the counting chamber 500 may include a carrier 510. The counting chamber 500 may be used for recognizing and counting an object (e.g., a cell, a bacterium, a fungus, or other particles) and may be applied in a cell counting device (e.g., a cell counter or a microscope, etc.). The carrier 510 may be used to hold a sample containing an object (e.g., particles) to be counted. In some embodiments, the dimension of the carrier 510 may be determined or set based on a practical requirement (e.g., a size of a carrier platform of the cell counting device), for example, the length of 57 mm, the width of 20 mm, and the thickness of 1.63 mm, or the length of 57 mm, the width of 20 mm, and the thickness of 1.0 mm.

In some embodiments, the carrier 510 may be provided with a concave sample sink 511. The sample sink 511 may be configured to accommodate a sample containing an object to be counted. The sample sink 511 may be formed in various shapes (e.g., an elongated shape, a circular shape, or a square shape, etc.). In some embodiments, the depth of the sample sink may be in a range from 0.05 mm to 3 mm (e.g., 0.05 mm, 0.1 mm, 0.15 mm, 0.3 mm, etc.). In some embodiments, the volume of the sample sink 511 may be in a range from 5 μl to 1000 μl (e.g., 5 μl, 100 μl, 200 μl, 500 μl, 800 μl, or 1000 μl, etc.). For example, the sample sink 511 may be an elongated shape with the depth of 0.2 mm, the length of 50 mm, and the width of 3.0 mm, accommodating the sample volume of 30 μl. As another example, the sample sink 511 may be with the depth of 0.83 mm, the length of 49.1 mm, and the width of 2.6 mm, accommodating the sample volume of 100 μl. In some embodiments, the sample sink 511 may be provided with at least one marker 6 for image stitching. In some embodiments, the at least one marker 6 may be a fixed marker relative to the sample sink 511. In some embodiments, the at least one marker 6 may be positioned on both side regions or in a middle region of the bottom surface of the sample sink 511. In some embodiments, the at least one marker 6 may be in a semi-circle shape, a sector shape, or an irregular shape, etc. When an imaging target surface 520 of an image acquisition device (e.g., a camera) of a cell counting device may not completely cover the sample sink 511, the sample sink 511 may be divided into sections for imaging based on the position of the at least one marker 6, and then detection images may be stitched based on the at least one marker 6, facilitating full volume imaging of the sample in the sample sink 511. The imaging target surface 520 of the camera refers to a range of a single imaging of the image acquisition device (e.g., a camera), and a size of the imaging target surface 520 may depend on factors such as a size of an imaging chip of the image acquisition device (e.g., a camera), a magnification factor configured in the cell counting device, etc.

In some embodiments, the sample sink 511 may be in an elongated shape, and the at least one marker 6 may include a plurality of markers 6 provided at equal intervals along the length direction of the sample sink 511. In some embodiments, the width of the sample sink 511 may be less than or equal to a lateral width (as shown horizontally in FIG. 7) of the imaging target surface 520 of the image acquisition device (e.g., a camera), and the lateral edge (e.g., 2.57 mm) of the imaging target surface 520 may move along the length direction of the sample sink 511 at equal intervals for imaging. Due to the even spacing of the plurality of markers 6 along the length direction of the sample sink 511, each detection image may include the plurality of markers 6, and adjacent detection images may be stitched together using the plurality of markers 6 in the detection images. After multiple imaging and stitching, a panoramic image (i.e., the full volume image) of the sample in the sample sink 511 may be obtained, and an object to be counted in the panoramic image may be statistically counted by the cell counting device.

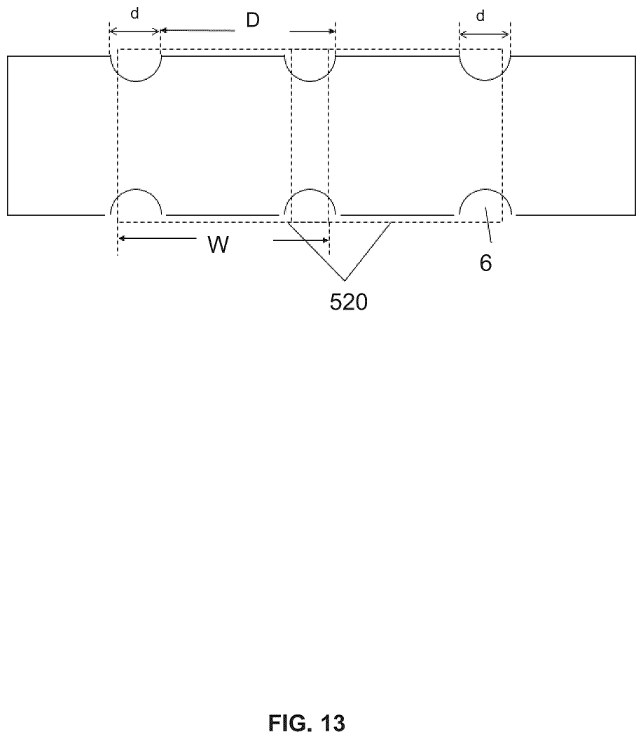

FIG. 13 is a schematic diagram of dimensions of the counting chamber 500 according to some embodiments of the present disclosure. As shown in FIG. 13, the maximum width of the inner bottom surface of the sample sink 511 of the counting chamber 500 may be slightly less than the vertical width (as shown vertically in FIG. 13) of the imaging target surface 520 of the image acquisition device (e.g., a camera) to ensure that a single imaging field fully covers the width of the sample sink 511. In some embodiments, the spacing D between two adjacent markers 6 in the sample sink 511 satisfies the formula: D<W<D+d, where W denotes the lateral width of the imaging target surface 520 of the camera, and d denotes a width of a single marker.

In some embodiments, the sample sink 511 may be the elongated shape, and a distance (e.g., the spacing D) between centers of two adjacent two markers 6 may be less than or equal to the length of an edge of the sample sink 511 in an imaging field. The distance between centers of two adjacent two markers 6 may refer to a distance between the centers of the two adjacent markers 6. For example, if the markers 6 are semi-circular, the distance between centers of two adjacent markers 6 is a distance between centers of two semi-circular arcs. By making the distance between centers of two adjacent two markers 6 less than or equal to the length of the edge of the sample sink 511 in the imaging field, two sides of the detection images obtained by moving the target imaging surface 520 at equal intervals along the length direction of the sample sink 511 may include the plurality of markers 6, making it convenient to stitch adjacent imaging images.

In some embodiments, the at least one marker 6 may include a semi-cylinder (as shown in FIGS. 7, 9, and 13) protruding inward on an inner wall of a long side of the sample sink 511. The semi-cylinder may be represented as a semi-circular notch (e.g., with a diameter of 0.6 mm) in the detection images, and the distance between centers of two adjacent two markers 6 may be a distance (e.g., 2.17 mm) between centers of two adjacent semi-circular notches. In some embodiments, the at least one marker 6 in the form of the semi-cylinder may be integrally formed with the carrier. The at least one marker 6 in the form of the semi-cylinder may facilitate production.

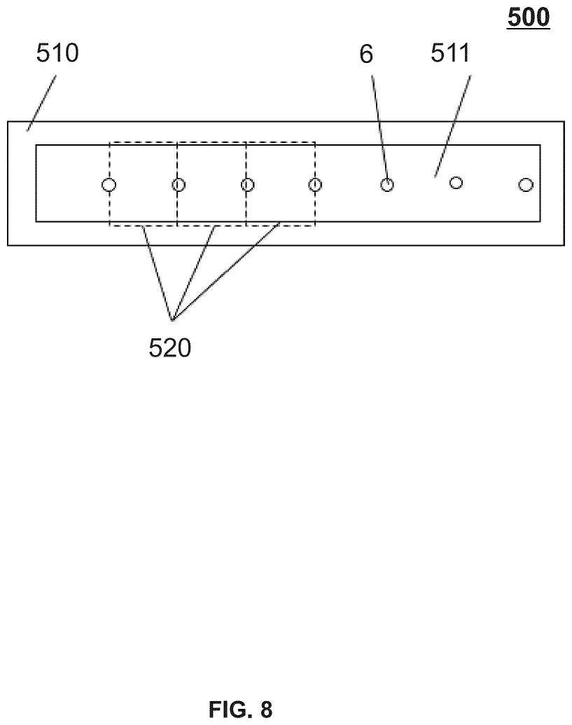

FIG. 8 is a schematic diagram illustrating an exemplary counting chamber 500 according to some other embodiments of the present disclosure. As shown in FIG. 8, in some embodiments, the at least one marker 6 may be provided at the bottom of the sample sink 511. In some embodiments, the at least one marker may be circular, elliptical, square, triangular, or irregular in shape, etc. As shown in FIG. 8, the at least one marker 6 may be a circular mark provided at the bottom of the sample sink 511 (e.g., with a diameter of 0.6 mm). In some embodiments, the roughness of the inner side of the at least one marker may differ from the roughness of the outer side of the at least one marker. In some embodiments, techniques such as laser engraving or abrasive polishing may be implemented on the inner side of the at least one marker to achieve different roughness on the inner side and the outer side of the at least one marker. During imaging, due to the difference in roughness on the inner side and the outer side of the at least one marker, the at least one marker may be recognized for the convenience of image stitching. In some embodiments, the material of the inner side of the at least one marker may differ from the material of the outer side of the at least one marker, resulting in a difference in transparency of the inner side and the outer side of the at least one marker. In some embodiments, both the roughness and the material between the inner side and the outer side of the at least one marker may be different.

In some embodiments, the sample sink 511 may be square, and the at least one marker 6 may include a plurality of markers 6 (e.g., circular marks) arranged in an array at the bottom of the sample sink 511. All four sides of the sample sink 511 may be larger than the lateral width and the vertical width of the imaging target surface 520 of the image acquisition device (e.g., a camera), and the plurality of markers 6 may be arranged in an array at the bottom of the sample sink 511. The imaging target surface 520 may move at equal intervals for imaging in lateral and vertical directions of the sample sink 511. The plurality of markers 6 may be used for image stitching.

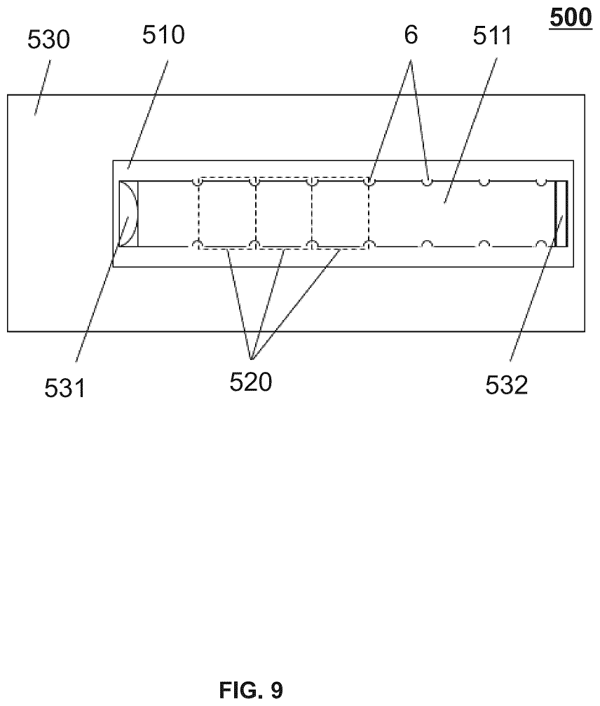

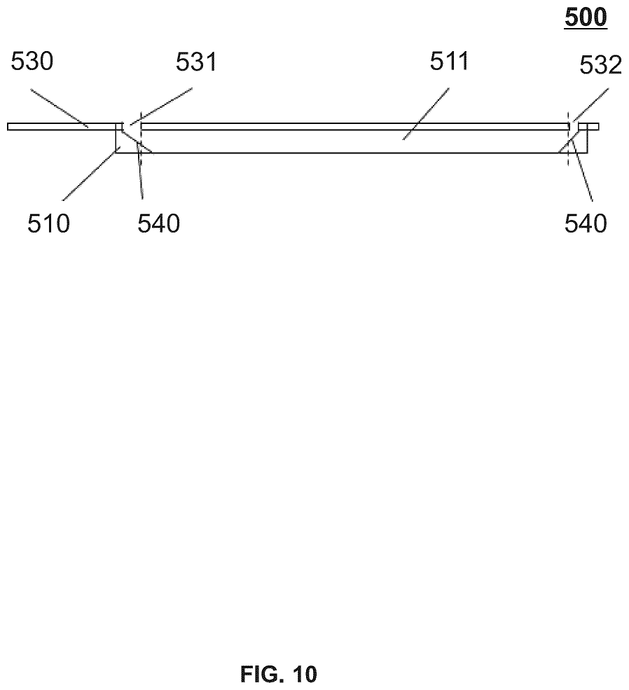

FIG. 9 is a top view of the counting chamber 500 according to some embodiments of the present disclosure, and FIG. 10 is a front view of the counting chamber 500 according to some embodiments of the present disclosure.

In some embodiments, the counting chamber 500 may include a cover 530 (e.g., with the length of 75 mm, the width of 26.4 mm, and the thickness of 0.9 mm), and the upper surface of the carrier 510 may fit with the lower surface of the cover 530. During use of the counting chamber 500, the cover 530 may be placed over the carrier 510, and the cover 530 and the carrier 510 may be securely fit with each other by means of adhesive, interlocking, or integral molding, or come into contact with each other to tightly fit together. In some embodiments, the upper surface of the concave sample sink 511 in the carrier 510 and the lower surface of the cover 530 are securely fit with each other by means of adhesive or Ultraviolet (UV) glue. In some embodiments, the cover 530 may be provided with a sample loading hole 531 (e.g., with the width of 2.5 mm, the length identical to the width of the sample sink 511, which is 2.6 mm or 3.0 mm) and an exhaust hole 532 (e.g., with the width of 1 mm, the length identical to the width of the sample sink 511, which is 2.6 mm or 3.0 mm). The sample loading hole 531 and the exhaust hole 532 may be positioned at two ends of the sample sink 511. The sample loading hole 531 may be used to introduce a sample into the sample sink 511, and the exhaust hole 532 may be used for venting the sample sink 511 (e.g., during sample loading). The exhaust hole 532 and the sample loading hole 531 may be configured as circular, elliptical, rectangular, rhomboidal, or irregular in shape. The exhaust hole 532 and the sample loading hole 531 may be of a same shape or different shapes.

In some embodiments, the sample sink 511 may be provided with a slope 540 at a position corresponding to the sample loading hole 531 and a slope 540 at a position corresponding to the exhaust hole 532. The slopes 540 may connect the bottom of the sample sink 511 and the upper surface of the carrier 510. In some embodiments, the exhaust hole 532 and the sample loading hole 531 may be covered by the corresponding slop 540 in a horizontal projection direction. Under the effect of the slopes 540 at the two ends of the sample sink 511, an object to be counted inside the sample sink 511 may accumulate near the bottom of the sample sink 511, which may prevent a contour structure of the sample loading hole 531 or the exhaust hole 532 from obstructing the object to be counted or affecting imaging when the sample sink 511 is imaged by a cell counting device, thereby avoiding an impact on a counting result.

In some embodiments, an angle between at least one of the slopes 540 and the bottom of the sample sink 511 may be in the range of 120° to 135° (e.g., 120°, 125°, 130°, or 135°, etc.). In some embodiments, the angle between at least one of slopes 540 and the bottom of the sample sink 511 may not be too large (e.g., close to 180°), as large angles may make it difficult for the object to be counted to accumulate completely at the bottom of the sample sink.

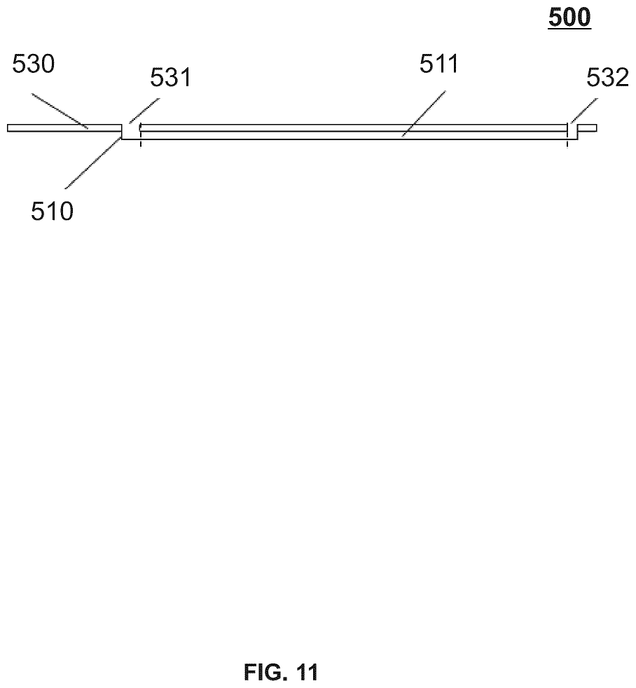

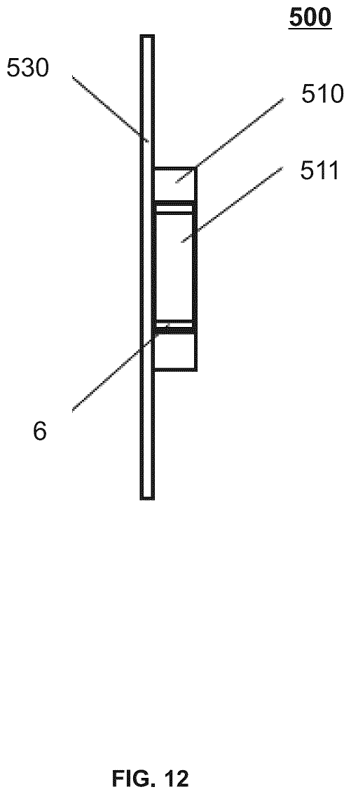

FIG. 11 is a front view of a counting chamber according to some embodiments of the present disclosure, and FIG. 12 is a side view of the counting chamber 500 according to some other embodiments of the present disclosure. As shown in FIGS. 11-12, in some other embodiments, the depth of the sample sink 511 may be less than 0.3 mm, and the sample sink 511 may be flush with the bottom of the sample sink 511 at positions corresponding to the sample loading hole 531 and the exhaust hole 532. In some embodiments, if the depth of the sample sink 511 is less than 0.3 mm, the slopes 540 may be not n inside the sample sink 511. If the bottom surface area of the sample sink 511 is sufficiently large, due to the capillary effect of liquid molecules and the surface tension of the liquid, a sample may accumulate in the middle of the sample sink. This may prevent a contour structure of the sample loading hole 531 or the exhaust hole 532 at two ends of the sample sink from obstructing an object to be counted or affecting imaging, thus avoiding an impact on a counting result.

In some embodiments, the carrier 510 may be a transparent carrier 510, and the cover 530 may be a transparent cover 530. Both the carrier 510 and the cover 530 may be made of an optically transparent material (e.g., glass). In some embodiments, both the carrier 510 and the cover 530 may be made of an optically transparent and chemically resistant material (e.g., polypropylene, polystyrene, etc.).

In some embodiments, operations for microbead counting using the counting chamber 500 may be shown as follows:

A cell lysis solution may be added to 1 ml of cell sample (the sample contains a small amount of microbeads) to fully lyse the cells, and the solution including the cell sample may be centrifuged to remove supernatant to obtain a preprocessed cell sample.

1 ml of Phosphate Buffered Saline (PBS) may be added to the preprocessed cell sample for one wash, and the washed cell sample may be centrifuged to remove the supernatant, and about 100 μl of precipitate may be generated.

The 100 μl of the precipitate may be added to the sample sink 511 of the disposable counting chamber 500 by using a pipette, ensuring that the liquid added to the sample sink 511 is continuous, without air bubbles or interruptions.

The counting chamber 500 may be standing horizontally for at least 1 minute, so that all the microbeads settle to the bottom of the sample sink 511.

The counting chamber 500 may be placed into an automatic cell counting device and the corresponding microbeads may be counted by bright-field imaging.

In some embodiments, operations for Acridine Orange Propidium Iodide (AOPI) cell viability counting using the counting chamber 500 may be described follows:

100 μl of cell suspension sample may be drawn using a pipette, and the sample may be mixed with 100 μl of an AOPI dye solution at a 1:1 ratio.

The evenly mixed 100 μl sample may be drawn and the mixed sample may be uniformly added to the sample sink 511 of the disposable counting chamber 500, ensuring that the liquid added to the sample sink 511 is continuous, without air bubbles or interruptions.

The counting chamber 500 may be inserted into corresponding equipment of a fluorescent cell counting instrument, and fluorescent imaging and counting of corresponding cells may be performed.

Some potential beneficial effects of the embodiments described in the present disclosure may include, but are not limited to: (1) The markers on the counting chamber may be used for the stitching of a plurality of imaging pictures during full volume imaging of the sample sink, enabling measurements of large volume and low concentration of test samples, with the characteristics of a simple structure, ease of use, time-saving, and high accuracy. This is beneficial for resolving and eliminating a distribution error caused by a distribution of objects to be counted and limited sampling; (2) The counting chamber may be cleaned and reused, or it may be used as a disposable item, which is simple to use and does not require installation and cleaning; (3) The sample size for a single test may reach 500 μl, greatly expanding a lower limit range of sample concentration detection, down to a minimum of 0 per ml. This is particularly suitable for counting and detection of low-concentration samples, significantly improving measurement accuracy and expanding the lower limit of detectable sample concentrations. It's important to note that different embodiments may produce different beneficial effects, and in different embodiments, the possible beneficial effects may be any combination of the above or other possible beneficial effects.

FIGS. 6A-6B are schematic diagrams of a system for analyzing particles in a test sample according to some embodiments described in the present disclosure.

In some embodiments, one or more operations of processes 100 and 200 may be performed by a computer system. Exemplary, one or more operations of processes 100 and 200 may be executed by the system for analyzing the particles in the test sample as shown in FIGS. 6A-6B.

As shown in FIG. 6A, a system 400 may be configured on any computing system. The system 400 may include a full volume image acquisition module 410 and an analysis parameter acquisition module 420.

The full volume image acquisition module 410 may be configured to obtain a full volume image of a test sample based on an image acquisition device. An imaging field of the full volume image may reflect an entire volume of the test sample within a sample container.

The analysis parameter acquisition module 420 may be configured to determine an analysis parameter of particles in the test sample based on the full volume image. The analysis parameter of the particles includes at least a count of the particles.

In some embodiments, the full volume image acquisition module 410 may be further configured to obtain the full volume image of the test sample based on a single imaging field on an imaging surface of the sample container.

As shown in FIG. 6B, in some embodiments, the full volume image acquisition module 410 may further include an imaging field determination unit 412 configured to determine a plurality of imaging fields of the image acquisition device on the imaging surface of the sample container and a detection image acquisition unit 415 configured to obtain at least one detection image of the test sample within each of the plurality of imaging fields. The detection images collected in two adjacent imaging fields may have an overlapping region. The full volume image acquisition module 410 may further include an image stitching unit 417 configured to stitch the detection images based on the overlapping region in the detection images to obtain the full volume image of the test sample. In some embodiments, the full volume image acquisition module 410 may further include an imaging field determination unit 412 configured to determine a plurality of imaging fields of the image acquisition device on the imaging surface of the sample container, and a detection image acquisition unit 415 configured to obtain at least one detection image of the test sample within each of the plurality of imaging fields. The detection images collected in two adjacent imaging fields have no overlapping regions. The full volume image acquisition module 410 may further include an image stitching unit 417 configured to stitch the detection images based on the overlapping region in the detection images to obtain the full volume image of the test sample.

In some embodiments, the sample container may be provided with a plurality of markers, and the overlapping region between two adjacent detection images may include at least one same marker. The image stitching unit 417 may be further configured to sequentially stitch the detection images based on the at least one same marker in the two adjacent detection images to obtain the full volume image of the test sample. In some embodiments, the plurality of markers may be provided at equal intervals on an edge of the sample container.

In some embodiments, the image stitching unit 417 may be configured to stitch two detection images in any adjacent imaging fields. The image stitching unit 417 may further include a first alignment module configured to determine a stitching range for a first alignment operation on the two detection images, and a second alignment module configured to perform a second alignment operation on the two detection images based on the at least one same marker to obtain the full volume image.

In some embodiments, the first alignment module may be further configured to determine the stitching range for the first alignment operation based on an imaging field distance of two imaging fields corresponding to the two detection images. The imaging field distance represents a distance between centers of the two imaging fields.

In some embodiments, the full volume image may be obtained through one of bright imaging field imaging, fluorescence imaging, or scattered light imaging.

In some embodiments, the analysis parameter acquisition module 420 may be further configured to process the full volume image based on an image recognition model to determine the analysis parameter of the particles. The image recognition model may be a machine learning model. In some embodiments, the image recognition model may include an image input layer configured to obtain the full volume image, a feature extraction layer configured to extract at least one of a color or a shape feature of the particles in the full volume image, and an analysis layer configured to output the analysis parameter of the particles based on at least one of the color or the shape feature of the particles in the full volume image.

It should be understood that the system shown in FIGS. 6A-6B and the modules thereof may be implemented in various ways. For example, in some embodiments, the system and the modules thereof may be implemented through hardware, software, or a combination of both. The hardware part may be implemented using dedicated logic, and the software part may be stored in memory and executed by an appropriate instruction execution device, such as a microprocessor or specialized hardware for execution. Those skilled in the art may understand that the methods and devices described herein may be implemented using a computer-executable instruction or included in processor control code, for example, provided on a carrier medium such as a disk, CD, or DVD-ROM, on programmable storage such as read-only memory (e.g., firmware), or on a data carrier such as an optical or electronic signal carrier. The system and the modules thereof may be implemented not only in hardware circuits such as Very Large Scale Integration (VLSI) circuits or gate arrays, semiconductor devices such as logic chips, transistors, or programmable hardware devices such as Field-Programmable Gate Arrays (FPGAs), but also in software executed by various types of processors. Additionally, they may be implemented by a combination of the above hardware circuits and software (e.g., firmware).

The potential benefits of the embodiments described in the present disclosure may include, but are not limited to: 1) acquiring an image (i.e., the full volume image) reflecting the entire volume of the test sample through an image acquisition device, eliminating the traditional sampling-statistical counting steps and eliminating the distribution error caused by uneven particle distribution; 2) avoiding the manufacturing error of the counting chamber and improving counting accuracy through full volume image detection; 3) achieving the stitching and recognition of a plurality of detection images through markers on the sample container. It should be noted that a dimension of the counting chamber may be adjusted according to application requirements to be applicable not only for particle counting but also for accurate counting and fluorescence analysis of various types of cells, as well as in medical clinical analysis fields such as blood cell counting and analysis of urine sediment. It should be pointed out that different embodiments may yield different beneficial effects. In various embodiments, the beneficial effects achieved may be any combination of the above, or any other possible beneficial effects.

The basic concepts have been described above, and it is apparent to those skilled in the art that the foregoing detailed disclosure is intended as an example only and does not constitute a limitation of the present disclosure. Although not expressly stated herein, those skilled in the art may make various modifications, improvements, and amendments to the present disclosure. Such modifications, improvements, and amendments are suggested in the present disclosure, so such modifications, improvements, and amendments remain within the spirit and scope of the exemplary embodiments of the present disclosure.

At the same time, specific terms are employed to describe the embodiments of the present disclosure. Terms e.g., “an embodiment,” “one embodiment,” and/or “some embodiments” are intended to refer to one or more features, structures, or features associated with at least one embodiment of the present disclosure. Thus, it should be emphasized and noted that the terms “an embodiment,” “one embodiment,” or “an alternative embodiment,” mentioned at different locations in the present disclosure two or more times, do not necessarily refer to a same embodiment. Additionally, certain features, structures, or features of one or more embodiments of the present disclosure may be appropriately combined.

Additionally, unless explicitly stated in the claims, the order of processing elements and sequences, the use of numerical or alphabetical characters, or the use of other names in the present disclosure are not intended to limit the order of the processes and methods. While various examples have been discussed in the disclosure as presently considered useful embodiments of the invention, it should be understood that such details are provided for illustrative purposes only. The appended claims are not limited to the disclosed embodiments, but instead, the claims are intended to cover all modifications and equivalent combinations that fall within the scope and spirit of the present disclosure. For example, although system components described above may be implemented through hardware devices, they may also be implemented solely through software solutions, e.g., installing the described system on existing processing equipment or mobile devices.

Similarly, it should be noted that, for the sake of simplifying the disclosure of the embodiments of the present disclosure to aid in understanding of one or more embodiments, various features are sometimes grouped together in one embodiment, drawing, or description. However, this manner of disclosure is not to be interpreted as requiring more features than are expressly recited in the claims. In fact, the features of various embodiments may be less than all of the features of a single disclosed embodiment.

Some embodiments use numbers to describe the count of components, and attributes, and it should be understood that such numbers used in the description of the embodiments are modified in some examples by the modifiers “about”, “approximately”, or “generally”. Unless otherwise stated, “about”, “approximately” or “generally” indicates that a variation of ±20% is permitted. Accordingly, in some embodiments, the numerical parameters used in the present disclosure and claims are approximations, which may change depending on the desired features of the individual embodiment. In some embodiments, the numeric parameters should be considered with the specified significant figures and be rounded to a general count of decimal places. Although the numerical domains and parameters configured to confirm the breadth of their ranges in some embodiments of the present disclosure are approximations, in specific embodiments such values are set as precisely as possible within the feasible range.

With respect to each patent, patent application, patent application disclosure, and other material, e.g., articles, books, manuals, publications, documents, etc., cited in the present disclosure, the entire contents thereof are hereby incorporated herein by reference. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and those described in the present disclosure, the descriptions, definitions, and/or use of terminology in the present disclosure shall prevail.

In closing, it should be understood that the embodiments described in the present disclosure are intended only to illustrate the principles of the embodiments of the present disclosure. Other deformations may also fall within the scope of the present disclosure. Thus, by way of example and not limitation, alternative configurations of embodiments of the present disclosure may be considered consistent with the teachings of the present disclosure. Accordingly, the embodiments of the present disclosure are not limited to the embodiments expressly presented and described herein.

1. A method for analyzing particles in a test sample, comprising:
obtaining a full volume image of the test sample using an image acquisition device; and
determining an analysis parameter of the particles in the test sample based on the full volume image.

2. The method of claim 1, wherein before the obtaining a full volume image of the test sample, the method further comprises:
performing an enrichment process on the test sample to obtain a processed test sample, the particles in the processed test sample aggregating at a bottom of a sample container.

3-4. (canceled)

5. The method of claim 1, wherein, when the particles include at least two types, before the obtaining the full volume image of the test sample, the method further comprises:
removing other types of particles in the test sample except for one target type of particles.

6. The method of claim 5, wherein the at least two types of particles include a transparent particle and a non-transparent particle, and the target type of particles is the non-transparent particle, the removing other types of particles in the test sample except for the target type of particles further includes:
adding a lysis solution to the test sample to lyse the transparent particle.

7. (canceled)

8. The method of claim 1, wherein the obtaining a full volume image of the test sample further includes:
obtaining the full volume image of the test sample based on a single imaging field on an imaging surface of a sample container, or
obtaining the full volume image of the test sample by stitching detection images corresponding to a plurality of imaging fields on the imaging surface of the sample container.

9. The method of claim 8, wherein the sample container is provided with a plurality of markers, and an overlap region between two adjacent detection images includes at least one same marker.

10. The method of claim 9, wherein the plurality of markers are provided at equal intervals on an edge or a bottom of the sample container.

11. The method of claim 8, wherein the obtaining the full volume image of the test sample based on a single imaging field on an imaging surface of a sample container further includes:
controlling a maximum width of the sample container to be less than a long side width of the single imaging field of the image acquisition device, such that the single imaging field completely covers the width of the sample container.

12. The method of claim 8, wherein the obtaining the full volume image of the test sample by stitching detection images corresponding to a plurality of imaging fields on the imaging surface of the sample container further includes:
determining the plurality of imaging fields of the image acquisition device on the imaging surface of the sample container;
obtaining at least one detection image of the test sample within each of the plurality of imaging fields, wherein detection images collected in two adjacent imaging fields have an overlapping region; and
stitching the detection images based on the overlapping region in the detection images to obtain the full volume image of the test sample.

13. The method of claim 8, wherein the obtaining the full volume image of the test sample by stitching detection images corresponding to a plurality of imaging fields on the imaging surface of the sample container further includes:
determining the plurality of imaging fields of the image acquisition device on the imaging surface of the sample container;
obtaining at least one detection image of the test sample within each of the plurality of imaging fields, wherein the detection images collected in the adjacent two imaging fields have no overlapping region; and
directly stitching the detection images to obtain the full volume image of the test sample.

14. The method of claim 12, wherein the sample container is provided with a plurality of markers, and the overlapping region between the two adjacent detection images includes at least one same marker; and
the stitching the detection images based on the overlapping region in the detection images to obtain the full volume image of the test sample further includes:
sequentially stitching the detection images based on the at least one same marker in the two adjacent detection images to obtain the full volume image of the test sample.

15. The method of claim 14, wherein the sequentially stitching the detection images based on the at least one same marker in the two adjacent detection images includes stitching two detection images in any adjacent imaging fields according to operations including:
determining a stitching range for a first alignment operation on the two detection images;
performing the first alignment operation on the two detection images based on the stitching range; and
performing a second alignment operation on the two detection images based on the at least one same marker to obtain the full volume image.

16. The method of claim 15, wherein the determining a stitching range for the first alignment operation on the two detection images further includes:
determining the stitching range for the first alignment operation based on an imaging field distance of two imaging fields corresponding to the two detection images, wherein the imaging field distance represents a distance between centers of the two imaging fields.

17. The method of claim 1, wherein the full volume image is obtained through one of bright imaging field imaging, fluorescence imaging, or scattered light imaging.

18. The method of claim 1, wherein the analysis parameter of the particles includes at least one of a count of the particles a percentage of each type of the particles, a concentration of the each type of the particles; or
characterizing a state of the particles, wherein the state of the particles includes one or more of a type of the particles, a morphological parameter of the particles, a concentration of the particles, or a distribution of the particles in different locations of the test sample.

19-21. (canceled)

22. The method of claim 1, wherein the determining an analysis parameter of the particles in the test sample based on the full volume image includes:
determining the analysis parameter of the particles by processing the full volume image based on an image recognition model.

23. The method of claim 22, wherein the image recognition model is a machine learning model generated through a training process including:
iteratively training an initial image recognition model based on a plurality of labeled training samples, wherein the image recognition model includes:
an image input layer configured to obtain the full volume image;
a feature extraction layer configured to extract at least one of a color or a shape feature of the particles in the full volume image; and
an analysis layer configured to output the analysis parameter of the particle to be analyzed based on at least one of the color or the shape feature the full volume image.

24. The method of claim 22, wherein the processing the full volume image based on an image recognition model further includes:
extracting at least one of a color or a shape feature of the particles in the full volume image; and
outputting the analysis parameter of the particles based on at least one of the color or the shape feature of the full volume image.

25-41. (canceled)

42. A counting chamber, comprising:
a carrier, wherein
the carrier is provided with a concave sample well; and
at least one marker for image stitching is provided in the sample well.

43-62. (canceled)

63. A system used for analyzing particles in a test sample, comprising:
a sample container, including the counting chamber including a carrier, wherein
the carrier is provided with a concave sample well; and
at least one marker for image stitching is provided in the sample well.
